(19) United States
(12) Patent Application Publication
(10) Pub. No.: US 2026/0155648 A1
(43) Pub. Date: Jun. 4, 2026

(54) OPTIMIZED DEVICE FOR PROTECTING AN ELECTRICAL LINE, ELECTRICAL SYSTEM AND AIRCRAFT

(71) Applicant: AIRBUS OPERATIONS SAS, Toulouse (FR)

(72) Inventor: Patrick BAREAUD, Toulouse (FR)

(73) Assignee: AIRBUS OPERATIONS SAS, Toulouse (FR)

(21) Appl. No.: 19/263,278

(22) Filed: Jul. 8, 2025

(30) Foreign Application Priority Data
Jul. 10, 2024 (FR) 2407537

(51) Int. Cl. H02H 7/26; H01H 85/046; H01H 85/38; H02H 9/04

(52) U.S. Cl. CPC H02H 7/268; H01H 85/046; H01H 85/38; H02H 9/042

(57) ABSTRACT

An optimized protection device configured to open a low-voltage electrical line in the event of an HVDC disturbance, while directing the potential occurrence of a secondary electric arc. Advantageously, it is thus possible to increase the safety of the systems by optimally isolating an electrical line in the event of HVDC disturbances above a predetermined magnitude.

### TECHNICAL FIELD

The present invention relates to a device for protecting a low-voltage electrical line and in particular to the protection of interface signals of aviation equipment which are on board and subjected to induced phenomena originating from high-voltage circuits. The invention also relates to an electrical system comprising one or more protection devices and to an aircraft comprising such an electrical system.

### PRIOR ART

The aviation industry is undergoing profound changes in terms of aircraft design, with the aim of significantly reducing emissions of carbon dioxide and nitrogen oxides, due to environmental and sustainability constraints.

The increased use of electrical energy in aircraft systems, and in particular propulsion systems, involves the use of numerous interconnected items of equipment which may use high-voltage electrical networks (including HVDC networks, HVDC being an acronym for “High-Voltage Direct Current”). This high-voltage equipment, called “HVDC equipment”, is also interconnected to the multiple systems already used in aircraft, such as computers and supervision systems, for example. Interface circuits called low-voltage interfaces are used to interconnect high-voltage equipment to low-voltage equipment or else to low-voltage energy sources. These new architectures introduce a new risk, namely the propagation of waves or more broadly HVDC disturbances in low-voltage circuits. Protection devices, such as fuses, programmed fuses, insulation barriers or else voltage limiters, can be used but the absence of an integrated solution leads to an increase in volume and mass of the circuits used, this going against a reduction in mass normally sought in aviation. Protection systems also use predetermined and calibrated points of weakness in printed circuit boards of equipment to allow electrical lines to be opened in the event of a fault and to limit or prevent the propagation of waves or high-voltage disturbances if a fault occurs. However, in some cases, such systems are not completely effective due to the occurrence of secondary electric arcs. There is therefore a need to limit the effects of secondary arcs by limiting the mass and volume characteristics of the systems as much as possible.

The situation can be improved.

### SUMMARY OF THE INVENTION

One object of the present invention is to limit the propagation of waves or high-voltage disturbances in electrical circuits by isolating the affected circuits and by controlling and directing possible secondary electric arcs.

To this end, a device for opening an electrical line of an electrical circuit is proposed, the opening device comprising a central part of the electrical line, having a first section of a predetermined size, and two distal parts of the electrical line each having a second section of a size larger than the size of said first section, and respectively connected to said central part, the opening device being such that:
each of the distal parts is connected to the central part via an electrical line intermediate part having a third section the size of which is between the size of the first section and the size of one of the second sections to which it is adjacent,
the portions of the electrical line, which are internal to said opening device, and where there are variations in size of the section of the electrical line, between said central part and said intermediate parts, on the one hand, and between each of said intermediate parts and said adjacent distal part, on the other hand, have right or substantially right angles, and
an end surface of a second electrical line is arranged facing one of said intermediate parts and has right or substantially right angles, so as to create an electric arc initiation zone when said central part breaks by melting.

Thus, in the event of HVDC wave disturbances on an electrical line, it is possible to direct a secondary arc arising after this electrical line has opened due to melting of the central part of such a device for opening an electrical line implemented on this electrical line, by virtue of an initiation zone created by the arrangement mentioned above.

According to one embodiment, the device is produced in the form of a printed circuit board.

The invention also provides an electrical system or circuit comprising at least one device for opening an electrical line as described above and at least one voltage-limiting device.

Another subject of the invention is an aircraft comprising at least one device for opening an electrical line as described above or an electrical circuit as mentioned above.

### BRIEF DESCRIPTION OF THE DRAWINGS

FIG. 1 illustrates a protection device for protecting by opening an electrical line, implemented on an electrical line, according to one embodiment;

FIG. 2 is a symbolic representation of the protection device already shown in FIG. 1;

FIG. 3 illustrates particular sizes and zones of the protection device already shown in FIG. 1;

FIG. 4 symbolically illustrates an interface circuit of an item of equipment comprising a protection device as already shown in FIG. 1, combined with a voltage-limiting device;

FIG. 5 symbolically illustrates an interface circuit of an item of equipment comprising two protection devices as already shown in FIG. 1, combined with a voltage-limiting device; and

FIG. 6 is a side view of an aircraft comprising at least one protection device advantageously configured to open an electrical line in the event of HVDC disturbances, according to one embodiment.

### DETAILED DESCRIPTION OF EMBODIMENTS

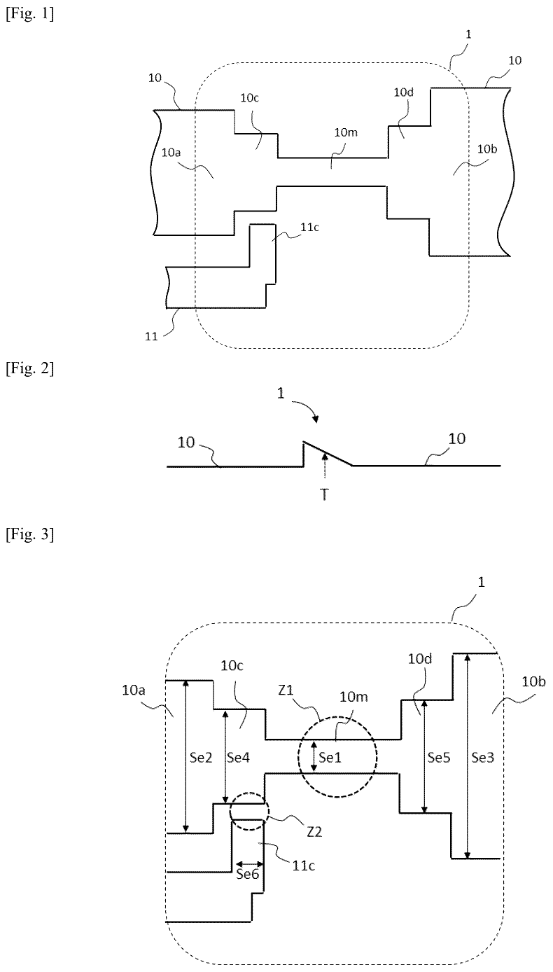

FIG. 1 schematically shows a protection device 1 for protecting by opening an electrical line, also referred to here as a device 1 for opening an electrical line. According to the example described, the opening device 1 is configured to be able to open the electrical line 10 if the latter is subjected to an HVDC disturbance that is likely to impair its integrity. To do this, the opening device 1 is implemented on the electrical line 10. In other words, the opening device 1 is integrated into the electrical line 10 which it protects. Obviously, elements of the opening device 1 are calibrated so that the opening device 1 opens the electrical line 10 under predetermined conditions.

The calibration of the opening device 1 according to the example described depends on the magnitude of the disturbance to be treated and is carried out by a person skilled in the art on the basis of information obtained via simulations or laboratory tests and/or studies.

To this end, the opening device 1 comprises a central part 10m and distal parts 10a and 10b respectively serving as interfaces for connection to the parts of the electrical line 10 that are not comprised in the opening device 1. Thus, the term “distal” here means that the parts 10a and 10b are the parts furthest from the central part 10m. These parts are useful for connecting the opening device 1 to the elements of the electrical line 10 which are external to it. Advantageously, the central part 10m has a section of a size substantially smaller than the sections of the distal parts 10a and 10b, so that, in the presence of an HVDC disturbance, the central part 10m behaves conditionally like a fuse when the energy passing through it exceeds a predetermined threshold value. Thus, if the energy then dissipated through the central part 10m is greater than the predetermined threshold value, the local temperature of the central part 10m is high enough to cause programmed deterioration (that is to say breaking by melting) of the central part 10m, this making it possible to limit the propagation of an HVDC disturbance of a predetermined minimum amplitude. Ingeniously and advantageously, intermediate connecting zones 10c and 10d, arranged between the central part 10m and the distal parts 10a and 10b, each have a section of an intermediate size between the size of the central part 10m and the section of the distal part which is directly connected thereto (which is immediately adjacent thereto). These intermediate connecting zones are also referred to here as intermediate parts. Ingeniously again, the intermediate parts 10c and 10d each have sharp angles, preferentially right or substantially right angles, so as to create corner effects (increased current density) in the presence of an HVDC disturbance. The term “substantially right” here describes angles of between 70 and 110 degrees, preferentially of between 80 and 100 degrees. Finally, a second electrical line 11, connected to a reference equipotential, for example a ground, is implemented in the vicinity of one of the distal parts of the opening device 1 and extends up to a predetermined distance from an edge of an intermediate part while having an end part 11c designed with sharp angles. Such an arrangement advantageously makes it possible to create a secondary arc initiation zone in the event that such a secondary arc were to form after the occurrence and potentially extinction of a primary arc between the remaining intermediate parts, after the central part 10m has melted following an HVDC disturbance beyond the threshold calibrated by the various sizes of the elements which make up the opening device 1. As a result, if a secondary arc were to arise in the event of an HVDC disturbance, it would be channelled by the initiation zone thus created.

Advantageously, the sections Se2 and Se3 (referenced in FIG. 3) of the distal parts of the opening device 1 are sized to withstand the maximum currents likely to occur both under normal operating conditions of the electrical line 10 and under abnormal conditions (that is to say in the presence of an HVDC disturbance). Furthermore, the section Se6 (referenced in FIG. 3) of the second electrical line 11, and of its end part 11c, must be larger than the section Se1 of the central part 10m of the opening device 1.

Obviously, the sizing characteristics of the sections described, and more broadly the sizing characteristics of all the elements of the opening device 1, cannot be defined intrinsically and are predetermined in dependence on the target disturbance level for which the opening device 1 must be opened, therefore in dependence on the location in an electrical circuit where the opening device 1 is used (or a device of similar architecture), and on the nature of the equipment to be protected.

A person skilled in the art of protection against high-voltage electrical disturbances will know how to calibrate the various sections of the opening device 1 described, while respecting the stated relative sizing conditions, on the basis of charts, preliminary tests, simulations with specialized and dedicated tools, or studies carried out during research and development work.

FIG. 2 is a symbolic representation of the opening device 1 operating as a normally closed switch (the opening of which is irreversible, however) on the electrical line 10 prior to an HVDC disturbance that is likely to cause it to open.

FIG. 3 repeats elements of FIG. 1 to which sizing references are added for the various elements which jointly make up the opening device 1. It can be seen that the central part 10m has a section Se1 that is smaller than the respective sections Se2 and Se3 of the distal parts 10a and 10b. Furthermore, the intermediate parts 10c and 10d each have an intermediate section between the section Se1 of the central part 10m and the section of the distal part to which they are respectively directly adjacent. Thus, the intermediate part 10c has a section Se4 that is larger than the section Se1 of the central part 10m and smaller than the section Se2 of the distal part 1a. Similarly, the intermediate part 10d has a section Se5 that is larger than the section Se1 of the central part 10m and smaller than the section Se3 of the distal part 10b. The described arrangement allows the implementation of a structure (or architecture) having sharp angles between the various parts mentioned above, adjacent to each other, so as to generate corner effects, namely physical phenomena of increased energy and current density in the corners having the sharp angles. Ingeniously, the creation of these current densities makes it possible to define electric arc initiation zones that are respectively the zone Z1 (circled by dotted lines) for the main arc resulting from melting of the central part 10m and the zone Z2 (also circled by dotted lines) ingeniously obtained owing to the above-mentioned implementation of the variations in sections and to that of the sharp angles, preferentially in the form of right angles.

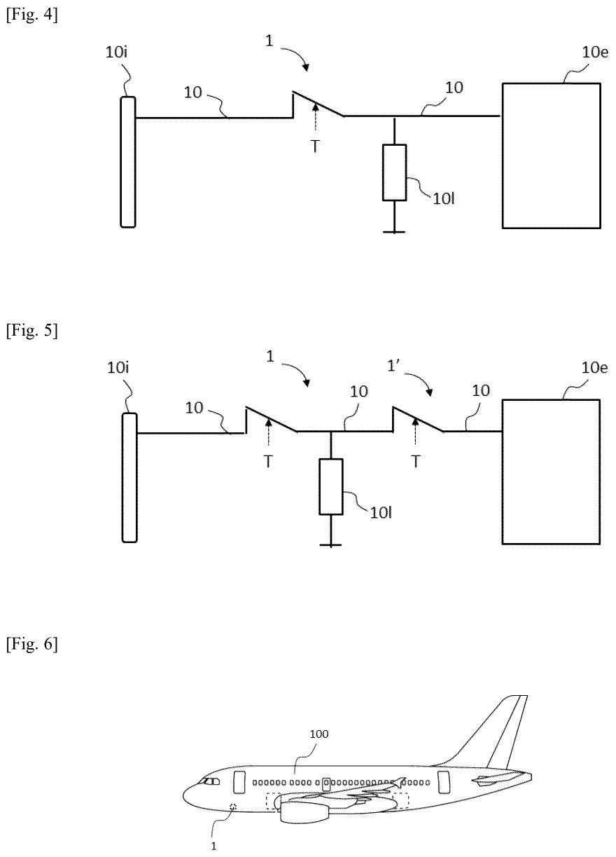

FIG. 4 symbolically illustrates the opening device 1 used in combination with a voltage-limiting device 10l to protect the electrical line 10 connected, on the one hand, to an item of electrical or electronic equipment 10e and, on the other hand, to a connection interface 10i. This arrangement makes it possible to protect the equipment 10e from HVDC disturbances passing through via the connection interface 10i, when the equipment 10e does not itself comprise an HVDC circuit (in the event of an HVDC disturbance from a source external to the equipment 10e). The voltage limiter 10l makes it possible to temporarily limit the voltage on the electrical line 10 to be protected, this making it possible to ensure that the residual voltage present in the event of an HVDC disturbance remains within acceptable limits for the electrical and/or electronic components connected to the electrical line 10 downstream of the opening device 1 in relation to the location from which a possible HVDC disturbance originates. Furthermore, the voltage-limiting device 10l is configured to absorb a large quantity of current, this making it possible to locally dissipate, by the Joule effect, enough energy to open the opening device 1 by melting its central part 10m. According to one embodiment, the voltage limiter 10l is a gas spark gap. According to one variant, the voltage limiter 10l is a transient suppression diode. These examples are not limiting and the voltage-limiting device 10l may be chosen from among all the devices capable of limiting harmful effects for the components arranged and connected downstream on the electrical line and to make it possible to absorb a quantity of current that is likely to lead to melting of the central part of the opening device 1.

In one particular embodiment, when the equipment 10e itself comprises at least one HVDC circuit and when there is then a risk of disturbance of an origin internal to the equipment 10e to be protected, it is possible to use a protection circuit as illustrated symbolically in FIG. 5, according to which the opening device 1 is used in combination with an opening device 1′ which has an identical structure to that of the opening device 1. This makes it possible to limit the risk of propagation of an HVDC disturbance originating from the equipment 10e to the connection interface 10i (in the event of an HVDC disturbance from a source internal to the equipment 10e), according to the same principle as stated above in relation to FIG. 4. The voltage-limiting device 10l is then connected to the electrical line 10 between the opening device 1 and the opening device 1′.

FIG. 6 illustrates an aircraft 100 comprising one or more opening devices similar to the opening device 1, this advantageously making it possible to limit the propagation of HVDC disturbances, if necessary, within equipment and to control the sequences of events following such an HVDC disturbance.

1. A device for opening an electrical line of an electrical circuit, said opening device comprising a central part of said electrical line, having a first predetermined section and two distal parts of said electrical line each having a second section larger than said first section (Se1) and respectively connected to said central part, the opening device wherein:
each of said distal parts is connected to said central part via an electrical line intermediate part having a third section between the first section and one of the second sections to which it is adjacent,
the portions of said electrical line, which are internal to said opening device, and where there are variations in section of the electrical line, between said central part and said intermediate parts, on the one hand, and between each of said intermediate parts and said adjacent distal part, on the other hand, have right or substantially right angles,
an end surface of a second electrical line is arranged facing one of said intermediate parts and has right or substantially right angles, so as to create an electric arc initiation zone when said central part breaks by melting.

2. The device for opening an electrical line according to claim 1, the device being produced in the form of a printed circuit board.

3. The electrical circuit comprising at least one device for opening an electrical line according to claim 1 and a voltage-limiting device.

4. An aircraft comprising at least one device for opening an electrical line according to claim 1.

5. The electrical circuit comprising at least one device for opening an electrical line according to claim 2 and a voltage-limiting device.

6. An aircraft comprising at least one device for opening an electrical line according to claim 2.

7. An aircraft comprising at least one device for opening an electrical circuit according to claim 3.
